(19) United States
(12) Patent Application Publication
(10) Pub. No.: US 2015/0174546 A1
(43) Pub. Date: Jun. 25, 2015

(54) FLUIDIZED BED REACTOR CAPABLE OF VARYING FLOW VELOCITY

(71) Applicant: KOREA INSTITUTE OF ENERGY RESEARCH, Daejeon (KR)

(72) Inventors: Chang-Keun Yi, Daejeon (KR); Ho-Jung Ryu, Daejeon (KR); Young-Cheol Park, Daejeon (KR); Sung-Ho Jo, Daejeon (KR); Gyoung Tae Jin, Daejeon (KR); Dowon Shun, Daejeon (KR); Dal-Hee Bae, Daejeon (KR); Jaehyeon Park, Daejeon (KR); Seung-Yong Lee, Daejeon (KR); Jong-Ho Moon, Daejeon (KR); Dong-Ho Lee, Daejeon (KR)

(73) Assignee: KOREA INSTITUTE OF ENERGY RESEARCH, Daejeon (KR)

(21) Appl. No.: 14/403,420

(22) PCT Filed: May 21, 2013
(86) PCT No.: PCT/KR2013/004446

§ 371 Date: Nov. 24, 2014

(30) Foreign Application Priority Data
May 23, 2012 (KR) 10-2012-0054667

(51) Int. Cl. B01J 8/26; B01J 8/18

(52) U.S. Cl. CPC B01J 8/26; B01J 8/1827; B01J 2208/00752; B01J 2208/00893

(57) ABSTRACT

The present invention relates to a fluidized bed reactor capable of varying flow velocity, in which the flow velocity in the fluidized bed reactor varies to maintain the smooth transportation of solid particles while increasing the concentration of a gaseous reactant in relation to the solid particles. The fluidized bed reactor comprises: a lower high-speed unit into which solid particles and fluid particles are introduced; a middle low-speed unit continuously connected to an upper portion of the lower high-speed unit so that the flow velocity therein becomes lower than that in the lower high-speed unit; and an upper high-speed unit continuously connected to an upper portion of the middle low-speed unit so that the flow velocity therein becomes higher than that in the middle low-speed unit.

### TECHNICAL FIELD

The present invention relates to a flow velocity variable type fluidized bed reactor, and more specifically to a flow velocity variable type fluidized bed reactor which is capable of maintaining smooth transfer of solid particles by varying flow velocity in the fluidized bed reactor while increasing concentration of a gaseous reactant with respect to the solid particles.

### BACKGROUND ART

Conventionally, a carbon dioxide (CO₂) capturing system employs a wet process to recover CO₂. That is, the wet process is carried out by passing CO₂-containing gas through an amine solution, to allow CO₂ to be absorbed into the solution and regenerating the solution in a regeneration column, thus reusing the solution. However, the wet process has a demerit of further generating waste water during an operation of the wet process.

In order to overcome disadvantages of the wet process, a dry process for recovering CO₂ has been proposed in the art. A system using the dry method is configured to recover CO₂ by using two reactors, wherein CO₂ fed into a absorption reactor is adsorbed to a solid absorbent (a dry absorbent) and removed. The solid absorbent inflows into a regeneration reactor (regenerator′) to remove the adsorbed CO₂, H₂O is adsorbed to the solid absorbent in a pre-treatment reactor, and then the solid absorbent is recycled to the absorption reactor.

However, as illustrated in FIG. 4, the absorption reactor has a problem that the quantity of sorbent existing in the reactor is continuously decreasing from the lower end portion into which absorbent is put in (see Daizo Kunii & Octave Levenspiel, Fluidization Engineering, Butterworth-Heinemann, 2nd Edition, 1991, page 195).

In particular, when using a fluidized bed reactor as the absorption reactor, the partial pressure of exhaust gas is lowered toward the upper side of the absorption reactor (see FIG. 5), and therefore the absorption ability of the absorbent is decreased with respect to the exhaust gas (see Esmail R. Monazam & Lawrence J. Shadle and Ranjani Siriwardane, Equilibrium and Absorption Kinetics of Carbon Dioxide by Solid Supported Amine Sorbent, AIChE Journal, 57(11), 3153-3159, 2011).

Accordingly, the conventional method has a problem that the absorption rate of CO₂ by the absorption reactor cannot increase any more.

### SUMMARY OF THE INVENTION

### Problems to be Solved by the Invention

In consideration of the above-described circumstances, it is an object of the present invention to provide a flow velocity variable type fluidized bed reactor which is capable of maintaining smooth transfer of solid particles by varying flow velocity in the fluidized bed reactor while increasing concentration of a gaseous reactant with respect to the solid particles.

### Means for Solving the Problems

In order to accomplish the above objects, there is provided a fluidized bed reactor in which solid absorbents and reaction gases inflow to cause chemical reaction between the solid absorbents and reaction gas in a fluidized state, including: a lower high-speed unit into which the solid particles and the liquid particles inflow; a middle low-speed unit which is connected to an upper end portion of the lower high-speed unit, and is configured to decrease a flow velocity therein to be lower than the lower high-speed unit; and an upper high-speed unit which elongates from an upper end of the middle low-speed unit, and is configured to increase the flow velocity therein to be greater than the middle low-speed unit.

Herein, the lower high-speed unit may have a smaller cross-sectional area than the middle low-speed unit, and the upper high-speed unit may have a smaller cross-sectional area than the middle low-speed unit.

In addition, the upper high-speed unit may have a cross-sectional area gradually decreased toward an upper end thereof.

Further, the reaction gases may be additionally supplied to the middle low-speed unit.

Further, the lower high-speed unit may have an extension part integrally formed at an upper end thereof, and the extension part may be disposed inside of the middle low-speed unit, and the additionally supplied reaction gases may be introduced into a lower position than an upper end of the extension part.

### Advantageous Effects

According to the present invention, even when the height of the solid particles having the same flow rate is increased, the reaction may actively occur due to an increase in the concentration of the reaction gases by additionally supplying the reaction gases, and the flow velocity at the position where the reaction gases are additionally supplied may adjust so as to be equal to or larger than that of the lower high-speed unit. Further, after ending of the reaction, the mixture of the gas and the solid particles may be smoothly transferred by again increasing the fluid velocity.

### BRIEF DESCRIPTION OF THE DRAWINGS

FIG. 1 is a schematic cross-sectional view illustrating a fluidized bed reactor according to a first embodiment of the present invention.

FIG. 2 is a schematic view illustrating a configuration of a carbon dioxide capturing system using the fluidized bed reactor illustrated in FIG. 1.

FIG. 3 is a schematic cross-sectional view illustrating a fluidized bed reactor according to a second embodiment of the present invention.

FIG. 4 is a graph illustrating absorption rate of absorbents depending on a height in a fluidized bed reactor.

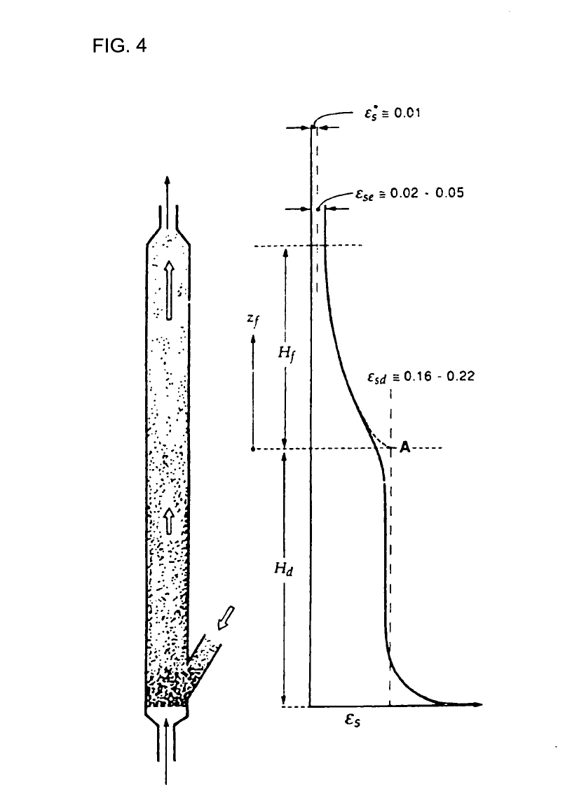

FIG. 5 is a graph illustrating absorption ability of absorbents depending on a partial pressure of exhaust gas.

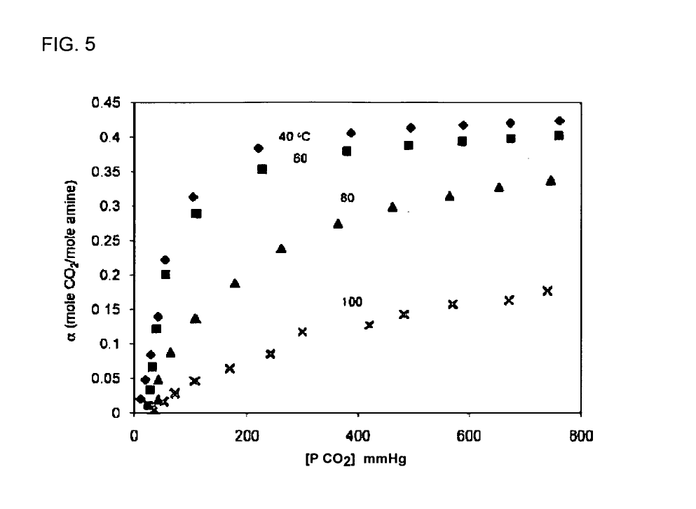

### MODES FOR CARRYING OUT THE INVENTION

Hereinafter, preferable embodiments of the present invention will be described with reference to the accompanying drawings. Referring to the drawings, wherein like reference characters designate like or corresponding parts throughout the several views. In the embodiments of the present invention, a detailed description of publicly known functions and configurations that are judged to be able to make the purport of the present invention unnecessarily obscure are omitted.

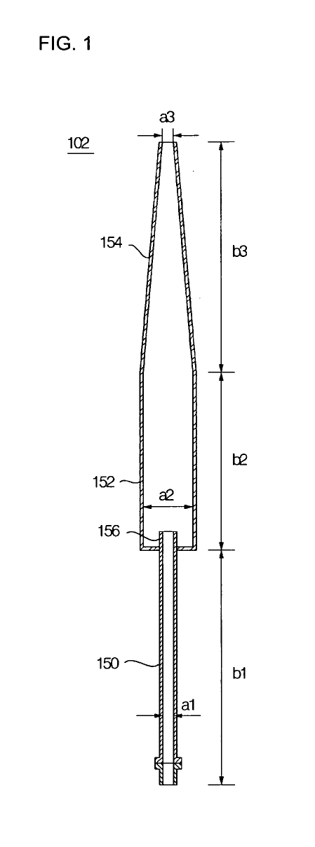

FIG. 1 schematically illustrates a fluidized bed reactor 102 according to a first embodiment of the present invention.

The fluidized bed reactor 102 has a configuration whose cross-sectional area is changed twice from a lower portion toward an upper side, unlike a conventional regenerator. That is, the fluidized bed reactor 102 includes a lower high-speed unit 150 into which solid particles and liquid particles inflow, a middle low-speed unit 152 which is connected to an upper end portion of the lower high-speed unit 150, and is configured to decrease the flow velocity therein to be lower than the lower high-speed unit 150, an upper high-speed unit 154 which elongates from an upper end of the middle low-speed unit 152, and is configured to increase the flow velocity therein to be greater than the middle low-speed unit 152.

In the lower high-speed unit 150, since the solid particles and reaction gases, which are not yet reacted while being fluidized, are present, a sufficient reaction may occur under a high flow velocity condition.

In addition, when the solid particles and reaction gases reach the upper side of the lower high-speed unit 150, a concentration of reactants contained in the reaction gases is lowered by a reaction in the lower high-speed unit, and thereby the reaction slowly occurs even when the solid particles still having reaction capability are present therein.

Therefore, in the present invention, the middle low-speed unit 152 configured to decrease the flow velocity therein to be lower than the lower high-speed unit 150 is disposed to the upper side of the lower high-speed unit 150. By this, if the flow velocity therein is decreased in the middle low-speed unit, contact time between the reaction gases and the solid particles is increased, so that sufficient reaction may occur therein even when the reaction velocity is slow. Therefore, most of the solid particles exhaust their reaction capability during passing through the middle low-speed unit 152. In the first embodiment of the present invention, the middle low-speed unit 152 is configured to decrease the flow velocity therein by having a larger cross-sectional area than the lower high-speed unit 150 (a1<a2).

However, when fluidization does not occur due to a decrease in the flow velocity, or the concentration of the reaction gas is low in spite of an increase in the pressure, it is possible to additionally supply the reaction gases to the middle low-speed unit 152. By this, the concentration of the reaction gas may be increased in the middle low-speed unit 152. However, when the flow rate of the added reaction gases is significantly increased, a fluidization phenomenon wherein the fluids move upward from the lower high-speed unit 150 by an air curtain effect may occur, and therefore an effect obtained by installing the middle low-speed unit 152 may be decreased.

Accordingly, it is preferable to avoid direct contact between the additionally supplied reaction gases and the solid particles. For this, as illustrated in FIG. 1, the lower high-speed unit 150 has an extension part 156 integrally formed at an upper end thereof. Herein, the extension part 156 is disposed inside of the middle low-speed unit 152 and the additionally supplied reaction gases may be introduced into a lower position than an upper end of the extension part 156. As a result, since the additionally supplied reaction gases collide with an outer peripheral surface of the extension part 156 and then move upward, the curtain effect which disturbs the flow of the solid particles and the reaction gases moving upward from the lower high-speed unit 150 may not occur.

When additionally supplying the reaction gases, it is possible to supply the reaction gases to a portion at which the middle low-speed unit 152 and the lower high-speed unit 150 are connected with each other. The upper high-speed unit 154 is disposed at the upper side of the middle low-speed unit 152 to increase the flow velocity therein, so that the reacted solid particles and the residual gas easily move to a subsequent process. For this, in the first embodiment of the present invention, the upper high-speed unit 154 is formed to have a smaller cross-sectional area than the middle low-speed unit 152 (a2<a3).

As illustrated in FIG. 1, the middle low-speed unit 152 has a cross-sectional area gradually decreased toward the upper end thereof, rather than the cross-sectional area being rapidly changed. Accordingly, as the solid particles and the residual gas move upward while passing there through, the flow velocity thereof may be gradually increased.

Herein, it is preferable that the flow velocity in the upper high-speed unit 154 is at least equal to or larger than that of the lower high-speed unit 150.

A length (b1) of the lower high-speed unit 150, a length (b2) of the middle low-speed unit 152, and a length (b3) of the upper high-speed unit 154 may be suitably selected depending on the type, flow rate and reaction velocity of the reaction gases and the solid particles.

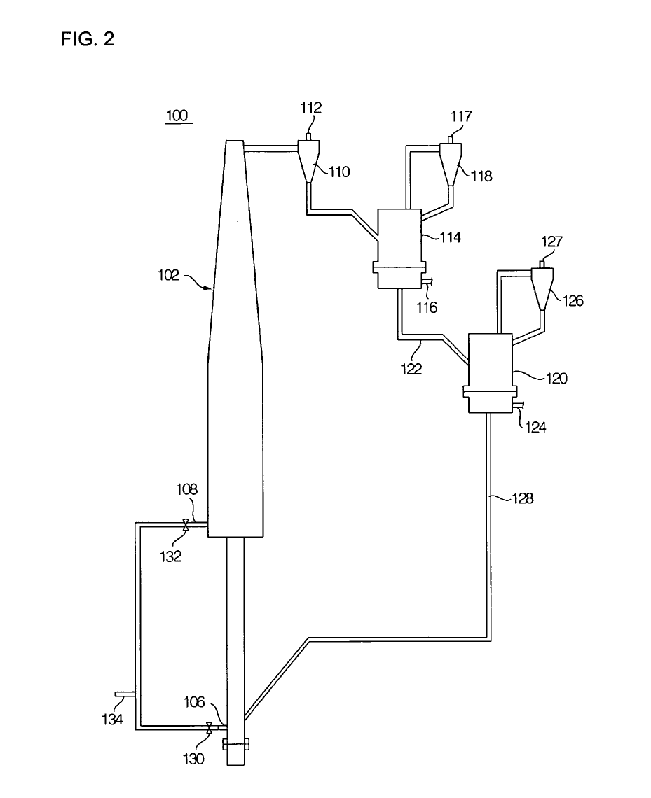

The fluidized bed reactor 102 according to the first embodiment of the present invention basically has the above described configuration. Next, a dry carbon dioxide (CO₂) capturing device 100 including the fluidized bed reactor 102 will be described with reference to FIG. 2. Components of the dry CO₂ capturing device 100 other than the fluidized bed reactor 102 are publicly known in the related art, and therefore, the configuration and operation thereof will be briefly described.

The dry CO₂ capturing device 100 includes the fluidized bed reactor 102 according to the first embodiment of the present invention, a fluidized bed cyclone 110, a regenerator 114 and a pre-treatment reactor 120. The pre-treatment reactor 120 basically has the same structure as the regenerator 114, but regenerated gas is supplied to the regenerator 114, while pre-treatment gas is supplied to the pre-treatment reactor 120.

The fluidized bed reactor 102 includes exhaust gas supply lines 106 and 108 which are respectively connected to the lower high-speed unit 150 and the middle low-speed unit 152 to supply exhaust gases of the reaction gases. The exhaust gas supply lines 106 and 108 include control valves 130 and 132 installed therein, and are connected to an exhaust gas supply source (not illustrated) through a main supply line 134. As described above, the exhaust gas supply line 108 connected to the middle low-speed unit 152 is disposed at the lower position of the upper end of the extension part 156.

Dry solid absorbent of the solid particle used in the dry CO₂ capturing device 100 may use any absorbent commonly used in the related art, and in particular, K₂CO₃ or Na₂CO₃ having favorable CO₂ adsorption is preferably used.

The fluidized bed cyclone 110 is an apparatus commonly known in the art, wherein the solid absorbent containing CO₂ absorbed therein (‘CO₂-absorbed solid absorbent’) in the fluidized bed reactor 102 is centrifuged to cause the solid absorbent to fall down by self-weight while light gas, that is, the exhaust gas free from CO₂ may flow through an isolated gas discharge line 112 connected to the fluidized bed cyclone 110 to further operations.

The regenerator 114 heats the CO₂-absorbed solid absorbent to allow the solid absorbent to release CO₂. Herein, a heating temperature of the solid absorbent is higher than the injection temperature of the exhaust gas. Heating the solid absorbent in the regenerator 114 is performed in a fluidized state by the regenerated gas inflowing from a regenerated gas supply line 116, wherein the regenerated gas may use steam. When using steam as the regenerated gas, removing moisture only from the regenerated gas may preferably provide pure CO₂. Then, the solid absorbent moves to the pre-treatment reactor 120 through am absorbent outlet line 122 connected to the regenerator 114.

The regenerator 114 may further include a regeneration cyclone 118 connected thereto so as to prevent loss of the solid absorbent suspended by the regenerated gas. The regeneration cyclone 118 may substantially have the same structure as that of the fluidized bed cyclone 110. Gas absorbed to the solid absorbent, i.e., CO₂ is discharged through a CO₂ discharge line 117 connected to the regeneration cyclone 118.

The solid absorbent passed through the regenerator 114 may have a temperature, at which CO₂ is easily absorbed in the pre-treatment reactor 120, and then, move to the fluidized bed reactor 102.

In order to cool the solid absorbent in the pre-treatment reactor 120, a pre-treatment gas is supplied thereto through a pre-treatment gas supply line 124. Such a pre-treatment gas may include, for example, air or inert gas such as nitrogen. A temperature of the pre-treatment gas should be at least equal to or less than the injection temperature of the exhaust gas fed to the fluidized bed reactor 102. In addition, the pre-treatment gas may rapidly cool the solid absorbent by fluidized bed motion of the solid absorbent in the pre-treatment reactor 120.

In addition, the dry solid absorbent containing H₂O absorbed therein has a characteristic in which CO₂ is easily soluble in H₂O, and may hence increase CO₂ absorption rate. Accordingly, it is preferable to supply the pre-treatment gas in a saturated water vapor state so as to early moisturize the solid absorbent.

The pre-treatment reactor 120 may include a pre-treatment cyclone 126 connected thereto to prevent the solid absorbent from being removed. Accordingly, the solid absorbent recovered by the pre-treatment cyclone 126 is fed back again to the pre-treatment reactor 120, while only the pre-treatment gas with absorbed thermal energy may be discharged through a pre-treatment gas discharge line 127. The solid absorbent discharged from the pre-treatment reactor 120 by contacting the pre-treatment gas with the solid absorbent should be controlled so as to have a temperature substantially identical to the injection temperature of the fluidized bed reactor 102.

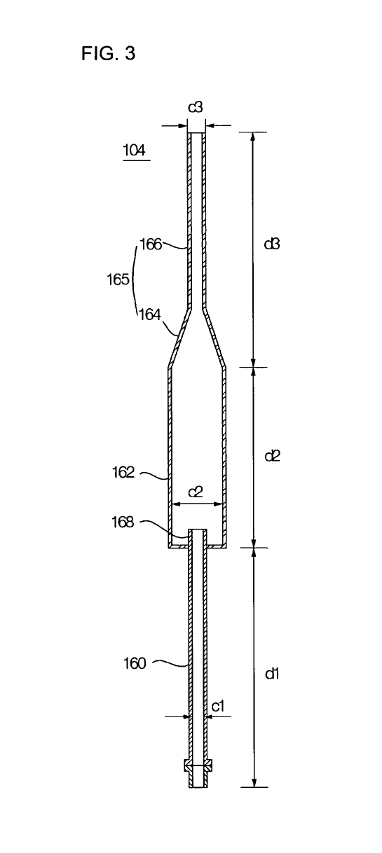

Next, a fluidized bed reactor 104 according to a second embodiment of the present invention will be described with reference to FIG. 3. The fluidized bed reactor 104 basically has the same configuration as the fluidized bed reactor 102 of the first embodiment, except for the configuration of the upper high-speed unit. An upper high-speed unit 165 of the fluidized bed reactor 104 includes a taper portion 164 and a small diameter portion 166. A lower high-speed unit 160, a middle low-speed unit 162, and an extension part 168 has the same configuration as the fluidized bed reactor 102 of the first embodiment, and therefore will not be described in detail.

While the present invention has been described with reference to the preferred embodiments, the present invention is not limited to the above-described embodiments, and it will be understood by those skilled in the related art that various modifications and variations may be made therein without departing from the scope of the present invention as defined by the appended claims.

### DESCRIPTION OF REFERENCE NUMERALS

100: dry CO₂ capturing device
102, 104: fluidized bed reactor
106, 108: exhaust gas supply line,
110: fluidized bed cyclone
112: isolated gas discharge line,
114: regenerator
116: regenerated gas supply line,
117: CO₂ discharge line
118: regeneration cyclone,
120: pre-treatment reactor
122: absorbent outlet line,
124: pre-treatment gas supply line
126: pre-treatment cyclone,
127: pre-treatment gas discharge line
128: absorbent reflow-in line,
130, 132: control valve
134: main supply line,
150, 160: lower high-speed unit
152, 162: middle low-speed unit,
154, 165: upper high-speed unit
156, 168: extension part,
164: taper portion
166: small diameter portion

1. A fluidized bed reactor in which solid absorbents and reaction gases inflow to cause chemical reaction between the solid absorbents and reaction gas in a fluidized state, comprising:
a lower high-speed unit into which the solid particles and the liquid particles inflow;
a middle low-speed unit which is connected to an upper end portion of the lower high-speed unit, and is configured to decrease a flow velocity therein to be lower than the lower high-speed unit; and
an upper high-speed unit which elongates from an upper end of the middle low-speed unit, and is configured to increase the flow velocity therein to be greater than the middle low-speed unit.

2. The fluidized bed reactor according to claim 1, wherein the lower high-speed unit has a smaller cross-sectional area than the middle low-speed unit, and the upper high-speed unit has a smaller cross-sectional area than the middle low-speed unit.

3. The fluidized bed reactor according to claim 1, wherein the upper high-speed unit has a cross-sectional area gradually decreased toward an upper end thereof.

4. The fluidized bed reactor according to claim 1, wherein the reaction gases are additionally supplied to the middle low-speed unit.

5. The fluidized bed reactor according to claim 4, wherein the lower high-speed unit has an extension part integrally formed at an upper end thereof, and the extension part is disposed inside of the middle low-speed unit, and the additionally supplied reaction gases are introduced into a lower position than an upper end of the extension part.
